(19) United States
(12) Patent Application Publication
(10) Pub. No.: US 2004/0058566 A1
(43) Pub. Date: Mar. 25, 2004

(54) Electrical connector with resilient reinforced fasteners

(76) Inventor: Hao-Yun Ma, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/406,513

(22) Filed: Apr. 2, 2003

(30) Foreign Application Priority Data
Sep. 25, 2002 (TW) 91215142

(51) Int. Cl. H01R 12/00

(52) U.S. Cl. 439/68

(57) ABSTRACT

An electrical connector (1) includes an insulative housing (11), and a frame (12) mounting on the housing. A pair of fasteners (112) protrudes from two diagonally opposite corners of the housing. The frame defines a pair of mounting holes (121) corresponding to the fasteners. Each fastener includes a lower portion (114) proximate to the housing, a medial portion (117) above the lower portion, and a top cap (113) above the medial portion. A diameter of each mounting hole is substantially the same as a diameter of either medial portion. A maximum diameter of each top cap is greater than the diameter of either mounting hole. A central blind hole (115) is defined in the top cap and medial portion of each fastener. Thus, the lower portion is solid. Accordingly, a strength and resiliency of the fastener is enhanced, and the housing is stably attached to the frame by the fasteners.

### BACKGROUND OF THE INVENTION

1. Field of the Invention

The present invention relates to an electrical connector for electrically connecting an electronic package such as a land grid array (LGA) chip with a circuit board such as a printed circuit board (PCB), and particularly to a two-part electrical connector with fasteners and mounting holes.

2. Description of Prior Art

Electrical connectors are widely used in personal computer (PC) systems to electrically connect land grid array (LGA) chips with printed circuit boards (PCBs). A typical electrical connector comprises an insulative housing, and a frame mounting on the housing. One or more fasteners fix the housing and the frame together. Thereby the LGA chip connects electrically with the PCB.

A conventional electrical connector is disclosed in “Nonlinear Analysis Help Design LGA Connectors” (CONNECTOR SPECIFIER, February 2001), for connecting an LGA chip with a PCB. U.S. Pats. Nos. 4,504,105, 4,621,884, 5,302,853, 4,692,790 and 5,344,334 all disclose a conventional fastener used in an electrical connector.

Referring to FIGS. 4, 5, and 6, a conventional electrical connector 9 comprises an insulative housing 91 and a frame 92. A pair of fasteners 912 upwardly protrudes from two diagonally opposite corners of the housing 91, respectively. A pair of through mounting holes 921 is defined in two diagonally opposite corners of the frame 92, corresponding to the fasteners 912 respectively. Each fastener 912 comprises a pair of symmetrical resilient posts 913. A recess 914 is formed between the resilient posts 913, thus the resilient posts 913 are cantilevers. Each resilient post 913 comprises a lower first cylindrical post 916 extending from a top surface of the housing 91, and a top second conical post 915 above the first cylindrical post 916. The top second conical post 915 has a locating face 917 parallel to the top surface of the housing 91.

In assembly of the housing 91 and the frame 92, the frame 92 is positioned above the housing 91. The top second conical posts 915 of the resilient posts 913 of the fasteners 912 are deformably inserted through the mounting holes 921 of the frame 92. When the top second conical posts 915 of the fastener 912 have completely passed through the mounting holes 921 of the frame 92, the top second conical posts 915 rebound to their original shapes such that the locating faces 917 of the top second conical posts 915 fittingly abut a top surface of the frame 92. Thus, the housing 91 is attached to the frame 92.

However, during assembly, each resilient post 913 is exerted upon by an inside wall of the of the frame 92 at the corresponding mounting hole 921. Thus, one end of the resilient post 913 proximate to the housing 91 sustains deformation. In addition, the resilient posts 913 are cantilevers. Accordingly, the resilient posts 913 are prone to distortion, and may even rupture after repeated assembly and disassembly. This results in the housing 91 not being securely attached to the frame 92.

A new electrical connector that overcomes the above-mentioned problems is desired.

### SUMMARY OF THE INVENTION

An object of the present invention is to provide an electrical connector having fasteners and mounting holes that facilitates stable assembly of a housing of the connector to a frame of the connector.

In order to achieve the above object, an electrical connector with fasteners and mounting holes in accordance with a preferred embodiment of the present invention comprises an insulative housing, and a frame mounting on the housing. A pair of fasteners protrudes from a pair of diagonally opposite corners of the housing, respectively. Each fastener comprises a lower portion connecting with a top surface of the housing, a medial portion above the lower portion, and a top cap above the medial portion. A central blind hole is defined in the top cap and medial portion of the fastener. The frame defines a pair of mounting holes corresponding to the fasteners, respectively. A diameter of each mounting hole is substantially the same as a diameter of the medial portion of either fastener. A maximum diameter of each top cap is slightly greater than the diameter of either mounting hole.

Other objects, advantages and novel features of the present invention will become more apparent from the following detailed description when taken in conjunction with the accompanying drawings, in which:

### BRIEF DESCRIPTION OF THE DRAWINGS

FIG. 1 is a simplified, exploded isometric view of an electrical connector in accordance with the preferred embodiment of the present invention, together with an LGA chip;

FIG. 2 is a partly cut-away view of the components of FIG. 1 assembled together;

FIG. 3 is an enlarged view of a circle portion III of FIG. 2;

FIG. 4 is a simplified, exploded isometric view of a conventional electrical connector, together with an integrated circuit (IC) chip;

FIG. 5 is a partly cut-away view of the components of FIG. 4 assembled together; and

FIG. 6 is an enlarged view of a circle portion VI of FIG. 5.

### DESCRIPTION OF THE PREFERRED EMBODIMENT

Reference will now be made to the drawings to describe the present invention in detail.

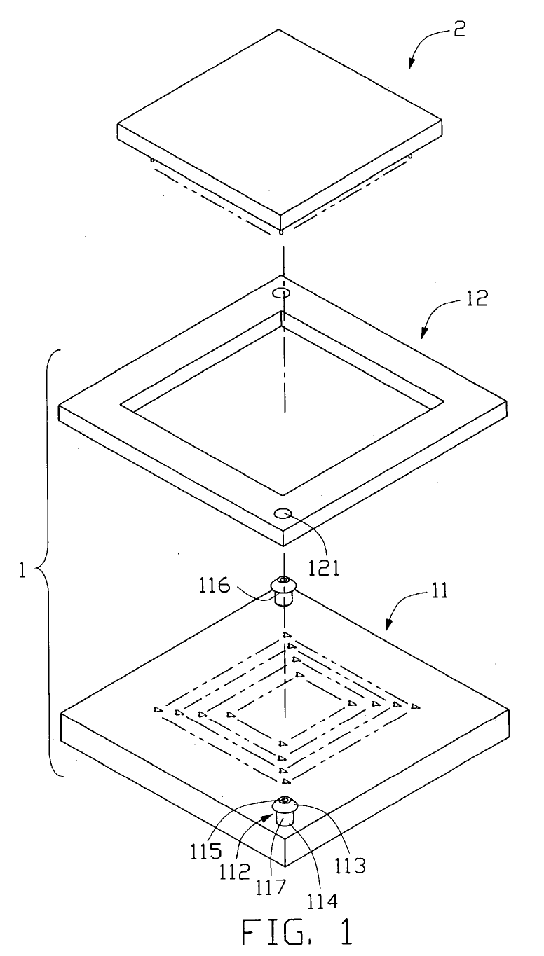

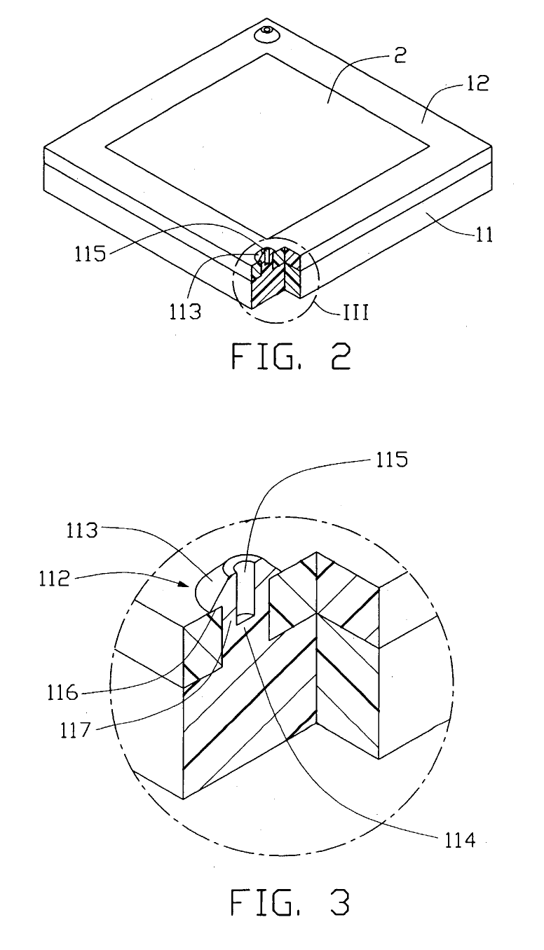

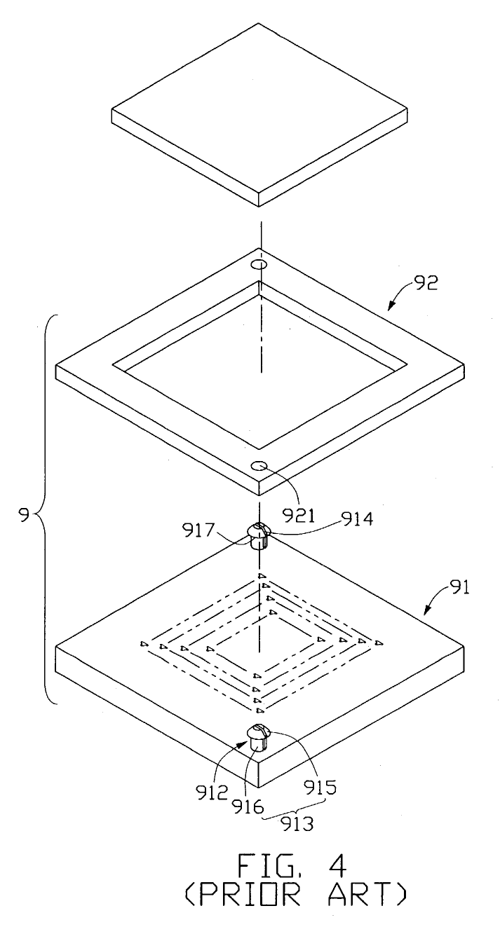

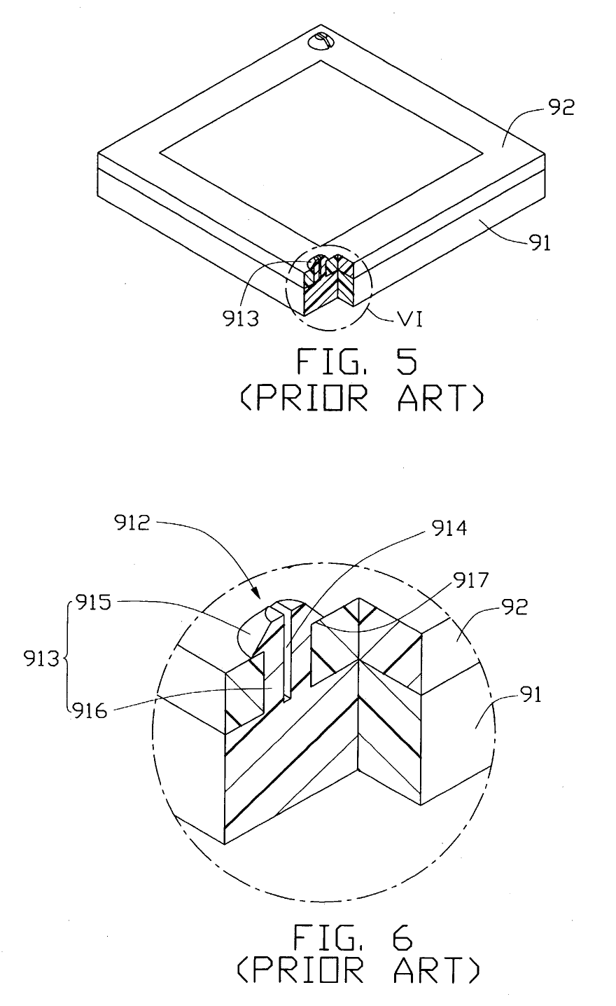

Referring to FIGS. 1 and 3, an electrical connector 1 in accordance with the preferred embodiment of the present invention comprises an insulative housing 11, and a frame 12 mounted on the housing 11.

The housing 11 comprises a multiplicity of terminals (not shown) received therein, for electrically connecting the connector 1 with a PCB (not shown). A pair of generally post-shaped fasteners 112 extends upwardly from diagonally opposite corners of the housing 11, respectively. Each fastener 112 comprises a solid cylindrical lower portion 114 connecting with a top surface of the housing 11, a hollow cylindrical medial portion 117 above the lower portion 114, and a conical top cap 113 above the medial portion 117. A maximum diameter of the top cap 113 is slightly greater than that of the medial portion 117. The top cap 113 has an annular bottom locating face 116 that is parallel to the top surface of the housing 11. A central blind hole 115 is defined in the top cap 113 and medial portion 117 of the fastener 112. Therefore, a top section of the fastener 112 comprising the top cap 113 and medial portion 117 is hollow. In addition, the lower cylindrical portion 114 of the fastener 112 is solid. Thus, a structure of the lower cylindrical portion 114 of the fastener 112 is reinforced.

An LGA chip 2 is mounted on the frame 12, so that the LGA chip 2 is connected with the PCB. A pair of mounting holes 121 is defined in diagonally opposite corners of the frame 12 respectively, corresponding to the fasteners 112 of the housing 11. A diameter of each mounting hole 121 is substantially the same as the diameter of the medial portion 117 of either fastener 112. A maximum diameter of each top cap 113 is slightly greater than the diameter of either mounting hole 121.

Referring also to FIG. 2, in assembly of the frame 12 and the housing 11, the frame 12 is positioned above the housing 11. The top caps 113 of the fasteners 112 of the housing 11 are deformably inserted through the mounting holes 121 of the frame 12. When the top caps 113 have completely passed through the mounting holes 121, the top caps 113 rebound to their original shapes such that the locating faces 116 of the top caps 113 fittingly abut a top surface of the frame 12. Thus, the frame 12 is securely attached to the housing 11. Because said top sections of the fasteners 112 are hollow, the top caps 113 have enhanced resiliency and flexibility. Therefore, the top caps 113 can readily pass through the mounting holes 121 of the frame 12. Because said structure of the lower cylindrical portions 114 of the fasteners 112 are reinforced, the lower cylindrical portions 114 resist distortion during assembly and in use thereafter. The risk of damage to the fasteners 112 is minimized. Because the maximum diameters of the top posts 113 of the fasteners 112 are slightly greater than the diameters of the mounting holes 121, the housing 11 remains securely and stably attached to the frame 12 in use. Accordingly, signal transmission between the LGA chip and the PCB is stable and reliable.

While a preferred embodiment in accordance with the present invention has been shown and described, equivalent modifications and changes known to persons skilled in the art according to the spirit of the present invention are considered within the scope of the present invention as defined in the appended claims.

What is claimed is:

1. An electrical connector for electrically connecting an electrical package with a circuit board, the electrical connector comprising:
a housing receiving a plurality of terminals;
a plurality of fasteners arranged on the housing, each of the fasteners comprising a lower portion proximate to the housing, a medial portion adjacent the lower portion, and a top cap extending from the medial portion; and
a frame mounted on the housing, the frame defining a plurality of mounting holes corresponding to the fasteners, a diameter of each of the mounting holes being almost equal to that of any of the medial portions;
wherein a hole is defined in a center of each of the fasteners, whereby a strength and resiliency of the fastener is enhanced.

2. The electrical connector as described in claim 1, wherein the hole is a blind hole defined in the top cap and the medial portion of the fastener.

3. The electrical connector as described in claim 1, wherein the fastener is generally post-shaped.

4. The electrical connector as described in claim 3, wherein a top section of the fastener comprising the top cap and the medial portion is hollow, the lower portion of the fastener is solid.

5. The electrical connector as described in claim 3, wherein the fasteners are arranged at two diagonally opposite corners of the housing.

6. The electrical connector as described in claim 1, wherein a maximum diameter of the top cap is slightly greater than a diameter of any of the mounting holes.

7. An electrical connector assembly comprising:
a rectangular insulative housing with at least two fasteners upwardly extending from a top face thereof, each of said fasteners including a cylindrical medial portion and a conical top cap with a central blind hole extending through both said cap and said medial portion axially but not radially so as to provide radial resiliency thereof; and
a frame located on the top face of the housing with at least a pair of through holes receiving the medial portions of the corresponding fasteners therein, respectively, the top cap abutting against a periphery of the corresponding hole on said top face and covering said corresponding hole.

8. The assembly as described in claim 7, further including an electronic package received in a center opening of said frame.

9. The assembly as described in claim 7, wherein said two fasteners are located diagonally on said housing.

10. The assembly as described in claim 7, wherein said fasteners are integrally formed with the housing.
